(19) United States
(12) Patent Application Publication
(10) Pub. No.: US 2015/0097487 A1
(43) Pub. Date: Apr. 9, 2015

(54) Plasma Confinement Device

(71) Applicant: Daniel Prater, Muncie, IN (US)

(72) Inventor: Daniel Prater, Muncie, IN (US)

(21) Appl. No.: 14/505,864

(22) Filed: Oct. 3, 2014

Related U.S. Application Data
(60) Provisional application No. 61/886,470, filed on Oct. 3, 2013.
(60) Provisional application No. 61/986,263, filed on Apr. 30, 2014.
(60) Provisional application No. 62/027,882, filed on Jul. 23, 2014.

(51) Int. Cl. H05H 1/16

(52) U.S. Cl. CPC H05H 1/16
USPC 315/111.71

(57) ABSTRACT

A device and method for magnetic field confinement of plasma is formed by a cylindrically stacked column of direct current-carrying magnetic field coils with electrodes adjacently interior to each magnetic field coils so as to induce plasma rotation about an annular confinement region. Each field coil produces a magnetic field alternating in direction relative to adjacent coils and, so as to maintain consistent overall azimuthal direction of plasma rotation, electric field electrodes alternate accordingly in polarity along the axial length of the device. The device may be used for inducing nuclear fusion, for the ionic or isotopic separation of elements, creation of thrust by ejecting mass along the axial direction of the device, for creating a gravitational acceleration field, and for creating a state change beyond plasma.

### CROSS-REFERENCE TO RELATED APPLICATIONS

This non-provisional patent application claims the benefit of and/or priority under 35 U.S.C. ♀119 to U.S. Provisional Patent Application Ser. No. 61/886,470 filed Oct. 3, 2013, entitled “Plasma Containment Device”, U.S. Provisional Patent Application Ser. No. 61/986,263 filed Apr. 30, 2014, entitled “Coaxial Mirror Confinement of Plasma”, and U.S. Provisional Patent Application Ser. No. 62/027,882, entitled “Device For Plasma Containment”, the entire contents of each one of which are specifically incorporated herein by this reference.

### FIELD OF THE INVENTION

The present invention relates in general to the subject of ionized gas (plasma) confinement, and specifically, to confinement of rotating plasma in a magnetic field where rotation is established by the interaction of plasma with an electric field disposed intersecting the magnetic field.

### BACKGROUND OF THE INVENTION

Devices for confinement of plasma in a magnetic field have, prior to date, failed to stably hold plasma for periods of time viable to commercial interest primarily due to formation of plasma instabilities. Leading approaches to magnetic confinement of plasma include tokomak-geometry reactors, magnetic mirror machines, Z-pinches, and many others well known to those skilled in the art of plasma physics.

A criterion for plasma stability was first discussed by Edward Teller who noted that plasma stability requires an outwardly-increasing magnetic pressure (a positive magnetic pressure gradient), which in practice, means a convex magnetic field shape as viewed outward from plasma.

U.S. Pat. No. 3,369,140 to H. P. Furth describes the annular confinement of high temperature plasmas between coaxial solenoidal field coils. This design, as are the other coaxial solenoid field coils designs of, for instance U.S. Pat. No. 3,189,523 to Patrick, is unable to achieve a sufficient mirror ratio, possess unfavorable concave magnetic field curvature radially outward from plasma (for example the IXION device of U.S. Pat. No. 3,005,767 to Boyer and the Homopolar generator of Anderson), are rotating shaft devices (for instance U.S. Pat. No. 4,710,660 to McKee), or do not alternate the polarities of adjacent magnetic fields such as to create adequate mirror reflection.

### SUMMARY OF THE INVENTION

Herein described is a device for the confinement of plasma in a magnetic field. Specifically the magnetic field is that formed by at least three current-carrying multi-turn coils, each alternating in magnetic field polarity in relation to its neighboring coil. Alternation of field polarity creates magnetic mirror reflection points along the device axis between field coils.

Interior to each field coil is an annular confinement region, which may be continuous in the axial direction with adjacent confinement regions of adjacent coils, formed by an annular vacuum vessel. On the interior surface of the outer wall of the vacuum vessel are electrodes, alternating in polarity with the alternation in polarity of the magnetic fields, thus creating electric fields approximately tangential to the magnetic fields established by the magnetic field coils and with vector cross product of the electric field E and the magnetic field B inducing a constant azimuthal direction of plasma drift.

By nature of the magnetic field within each confinement region, magnetic pressure increases radially outward toward the magnetic field coil. Plasma, rotating the annular confinement region at the plasma drift velocity due to the interaction of charged particles with intersecting electric and magnetic field components, is forced outward against this increasing magnetic pressure gradient at an amount balancing inward particle diffusion motion or above.

Plasma compression is thereby accomplished by increasing rotational velocity by increasing electric field strength accompanied by an increase in magnetic field strength to balance the increased centrifugal force. In this way centrifugal force may be viewed as a centrifugal pressure which in the present invention is balanced by magnetic pressure and in which the rotation of the plasma is driven by the electric field. These forces balance the radial motions of particles across the magnetic field lines, including those motions of particle diffusion. Along the magnetic field lines plasma particles are confined by the magnetic mirror effect.

The present invention provides magnetic mirror confinement of plasma in the annular region interior to magnetic field coils. The basic geometry of these magnetic field coils is a stack, or cylindrical column, each coil of the stack alternating in field polarity in relation to adjacent coil and each electrode adjacently interior to each field coil also alternating in polarity in relation to adjacent electrodes. Alternation in magnetic field polarity is accomplished either by alternating direct current direction or by alternating coil-winding direction. Alternately, the coils may be formed of conductive plates such as the Bitter type. The annular confinement region for plasma is the annular region inside the cylindrical column of coils, within a vacuum vessel, with electrodes disposed so as to create an electric field alternating in direction. It is inherently a direct-current device. Due to a plasma stabilizing effect of velocity shear in the azimuthal velocity, meaning an azimuthal velocity gradient in the radial and axial direction toward mirror reflection points, the electrodes and coils may be shaped to produce an increasing electric field nearer the magnetic mirror reflection regions between adjacent field coils.

Combination of the magnetic field and electric field imparts on charged particles an azimuthal drift, and therefore in this geometry, a rotation of the annularly confined plasma. The direction of rotation is in the direction of the plasma drift velocity and also in the direction of the Poynting vector, thus imparting a means for understanding momentum transfer to the plasma from the electric and magnetic fields by means of Poynting's theorem.

Generation and heating of plasma are by any means known to those with skill in the art, including ion cyclotron resonance heating, capacitive-coupled generation, neutral beam injection heating, and the like.

The present invention satisfies Teller's criterion for plasma stability outwardly from plasma, while inwardly plasma is held by a centrifugal force of rotation, and along field lines by the magnetic mirror effect. Plasma stabilization is by means of a convex field shape as viewed outwardly from the confined plasma, and by means of velocity shear.

Those of skill in the art will understand that various details of the invention may be changed without departing from the spirit and scope of the invention. Furthermore, the foregoing description is for illustration only, and not for the purpose of limitation, the invention being defined by the claims.

### BRIEF DESCRIPTION OF DRAWINGS

The mentioned and other features and objects of this invention, and the manner of attaining them, will become more apparent and the invention itself will be better understood by reference to the following description of an embodiment of the invention taken in conjunction with the accompanying drawings.

FIG. 1 is a cylindrical cutaway view along the cylindrical axis of an embodiment of the device showing three magnetic field coils (100a, 100b, 100c) and two partial field coils of N number of field coils possessing currents alternating in direction as indicated using conventional notation (i.e., into page, X, out of page, dot), magnetic field lines (101) produced by the magnetic field coils with directions as indicated by arrows following convention, approximate location and shape of plasma (102), and approximate location and shape of electrodes 103a, 103b, 103c, and etc. with polarities alternating as indicated (+) and (−) producing electric field as indicated by dashed lines and arrows 104. Mirror regions 105 are encircled by ovals within which are mirror reflection points. Also indicated is a coordinate axis showing for reference axial direction z, radial direction r, and azimuthal direction theta. Bold text with the text description indicates values and features with directionality, such as vectors and tensors.

FIG. 2 is a 90-degree counterclockwise rotation of FIG. 1 with axis of symmetry at the bottom showing E and B fields in isolated relief.

FIG. 3 is a 90-degree clockwise rotation of FIG. 1 with axis of symmetry at the top showing E and B fields in isolated relief.

FIG. 4 is a 180-degree rotation of FIG. 1 with axis of symmetry at the right showing approximate gravitational field curvature vector G in the plane of the figure, where G is related to the stress-energy tensor in Einstein's field equations as is known to those with skill in the art (see Relativity Reference Misner, Thorne, Wheeler), direction of mass m ejection through the loss cone as is known to those with skill in the art of magnetic mirror particle reflection, and the direction of the Poynting vector S for the example embodiment of FIG. 1.

FIG. 5A is a graph showing two contour lines. Interior contour s1 traverses the center of plasma, originating along the interior equatorial plane of the plasma, intersecting points a, b, c, and extending to a first mirror reflection point along the positive axial z and radial r directions local to confined plasma. Exterior contour s2 traverses from a positive axial z and radial r mirror reflection point, along the inner surface of the confined plasma to a second mirror reflection point and continues along the outer surface of confined plasma to the first mirror reflection point.

FIG. 5B is a dual graphical illustration of velocity shear and Larmor radius of individual particles, showing along the ordinate direction the contour s1 and points a, b, c, of FIG. 5A and along the abscissa direction plasma drift velocity v_{d} where v_{d}=E×B/|B|². Shown also are relative sizes of the plasma particle Larmor radius along s1. It is an object of the present invention that plasma azimuthal velocity be greater closer to points of magnetic mirror reflection for purposes of plasma stabilization by velocity shear.

FIG. 5C is a graph showing calculations for mirror ratios Mr along the inner and outer arc of plasma surface as indicated in FIG. 5B along contour s2 for a hypothetical device configuration having magnetic field intensity B, in units of Tesla on the ordinate axis and length along contour s2 on the abscissa axis. It is an object of the present invention that the mirror ratio along the outer arc of the plasma is sufficient to induce mirror reflection despite increased confinement duty placed upon mirror reflection by centrifugal force of plasma particle rotation. In common practice this value should exceed about 2.

FIG. 6 depicts plasma 102, magnetic confinement field lines 101 originating from current I into the page as indicated in field coil 100. Confinement of plasma in a magnetic field with curvatures and gradients in field strength as discussed herein and known to those with skill in the art will induce differential movements of particles as a function of their individual mass and electrical charge. These differential movements will induce internal plasma currents of sum J found by first order orbit theory analysis to occur along the Poynting vector S, in the direction of plasma fluid flow, where S=E×H following standard notation (see Cambel). The result of internal plasma current J is magnetic field B⁺ contributing to stabilization or plasma pinch as is known to those with skill in the art. Due to velocity shear and differential curvatures B⁺ may vary along S1.

FIGS. 7A and 7B provide a depiction of acceleration a in the near neighborhood of plasma 102 when the plasma is above (FIG. 7A) and below (FIG. 7B) the equatorial mass plane 106 (here depicted as a man and two test masses inside and outside of the plasma along an equatorial plane). According to Thirring and Einstein (see Relativity references) a rotating hollow body such as plasma 102 will induce spacetime curvature here noted in the plane of the page by G inducing local accelerations a.

Not drawn is matter state change from plasma to a state of higher density matter, for example quark-gluon plasma, or glasma, or both, occurring upon sufficient energy input into plasma. It is an object of the present invention to describe means for producing such matter state changes and theory presently states that approx. 175 MeV of energy input into plasma particles will induce such a state change, this energy input in the present invention due to energy input to plasma along the Poynting vector or from heating means or both, and such a state change may be inevitable in creating adequate spacetime curvature G necessary for practical use.

It should be appreciated that not all of the features of the components of the figures are necessarily described. Some of these non-discussed features as well as discussed features are inherent from the figures. Other non-discussed features may be inherent in component geometry and/or configuration.

### DETAILED DESCRIPTION

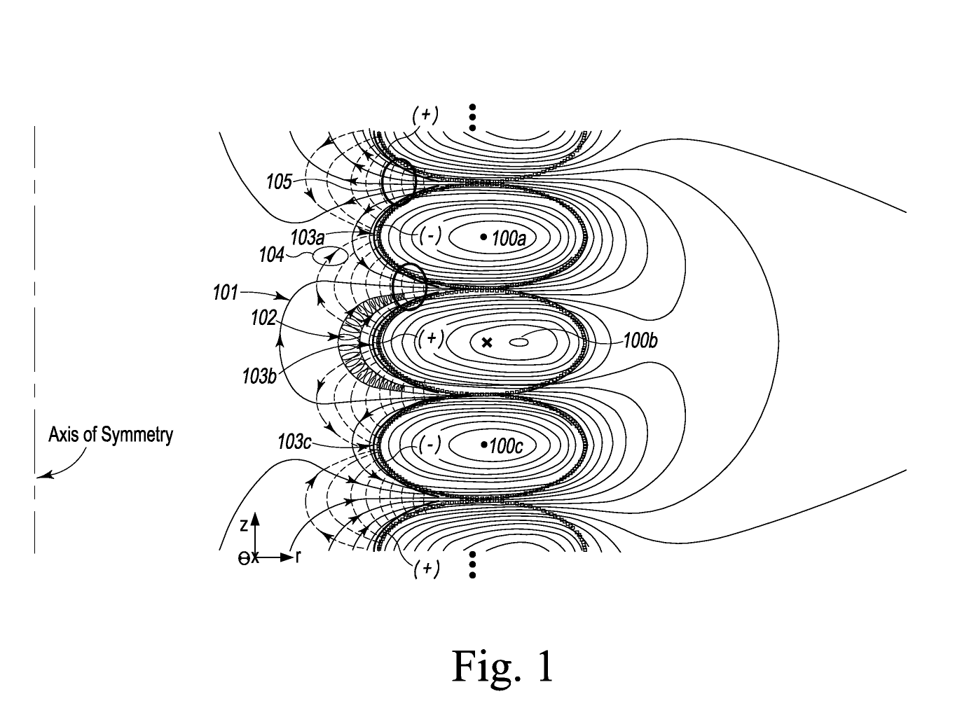

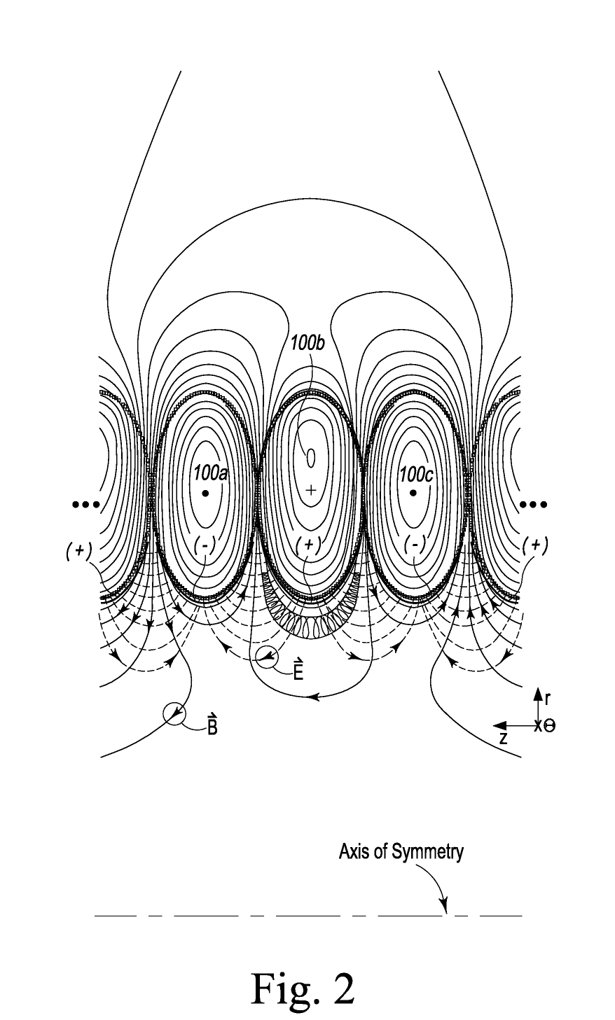

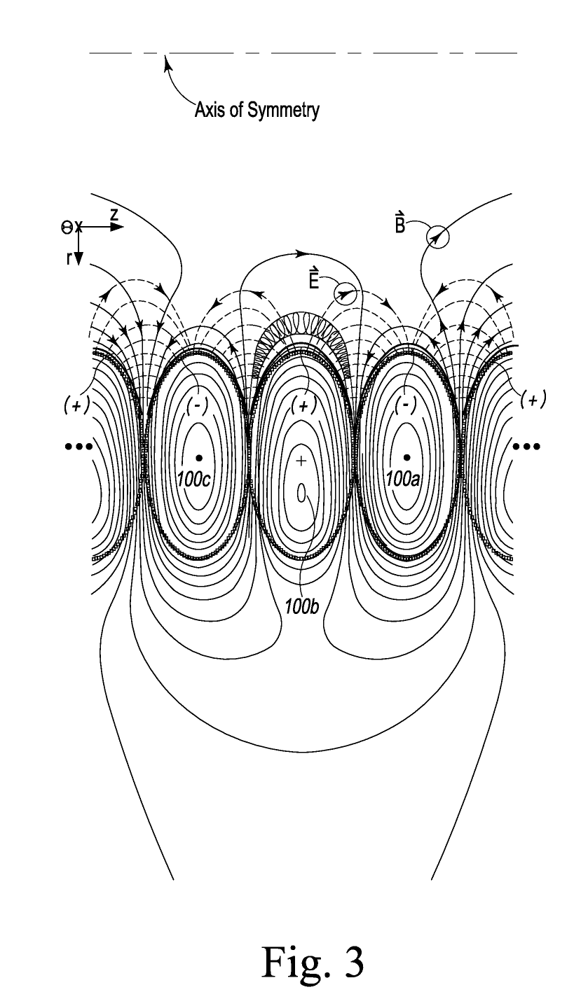

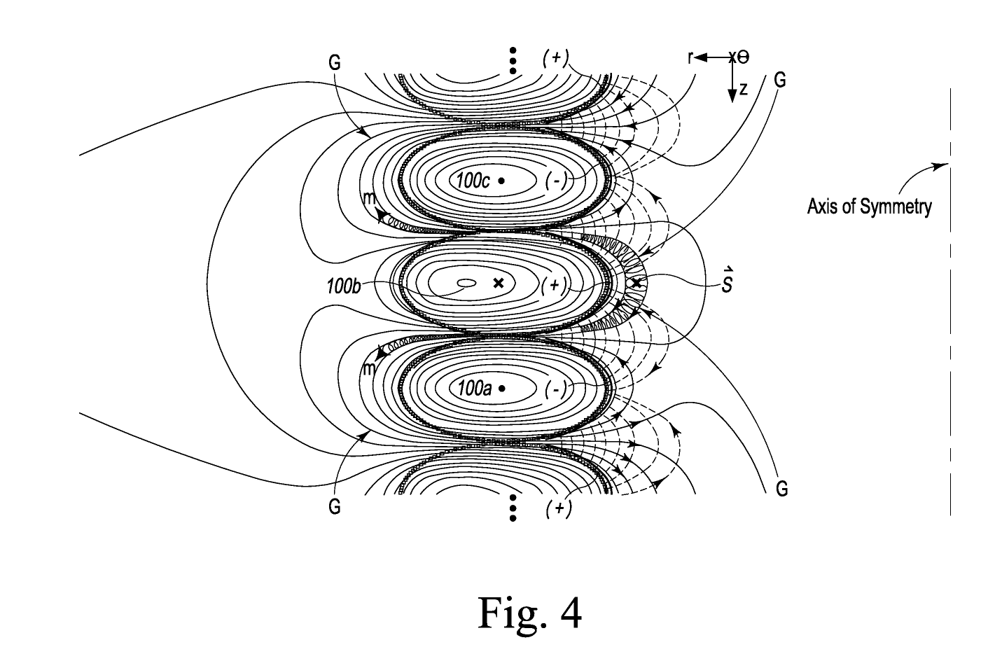

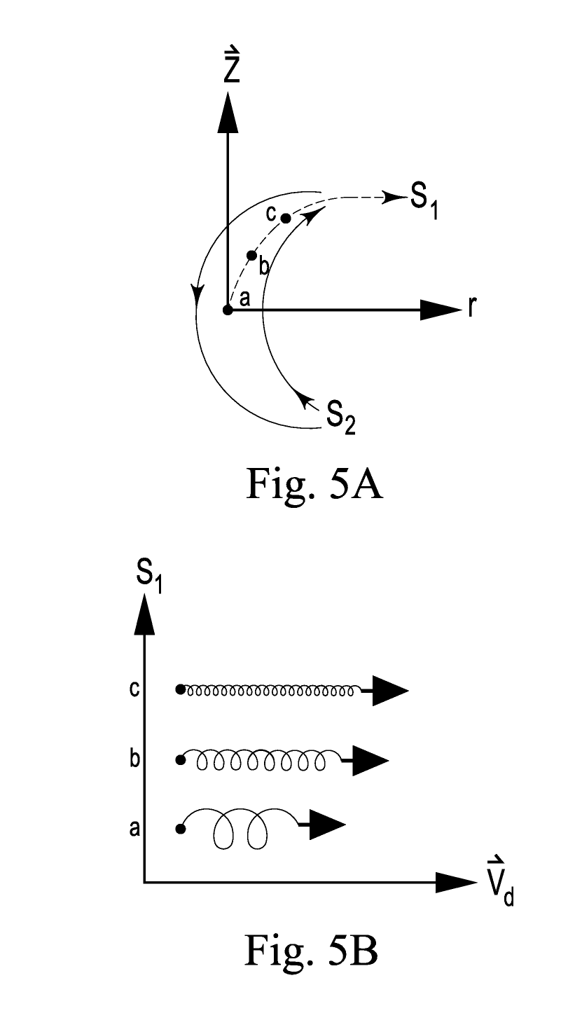

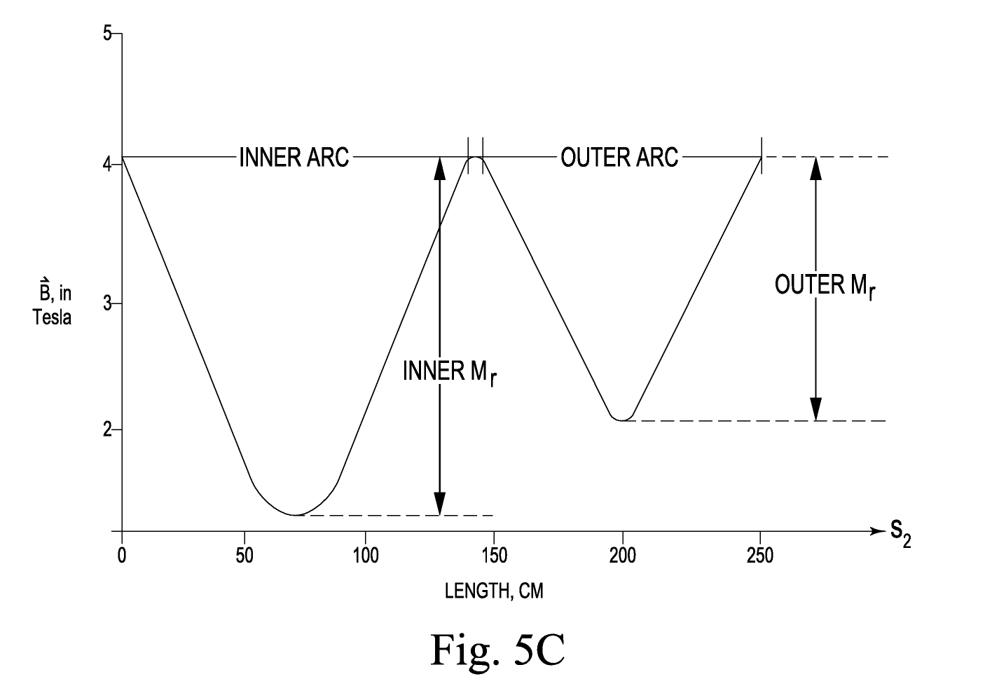

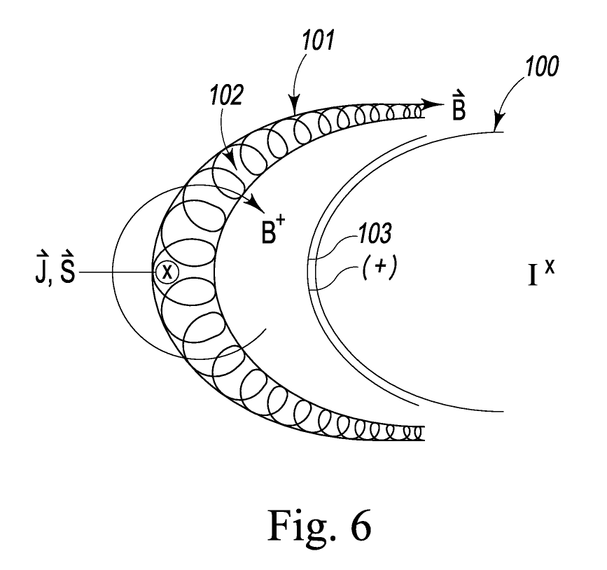

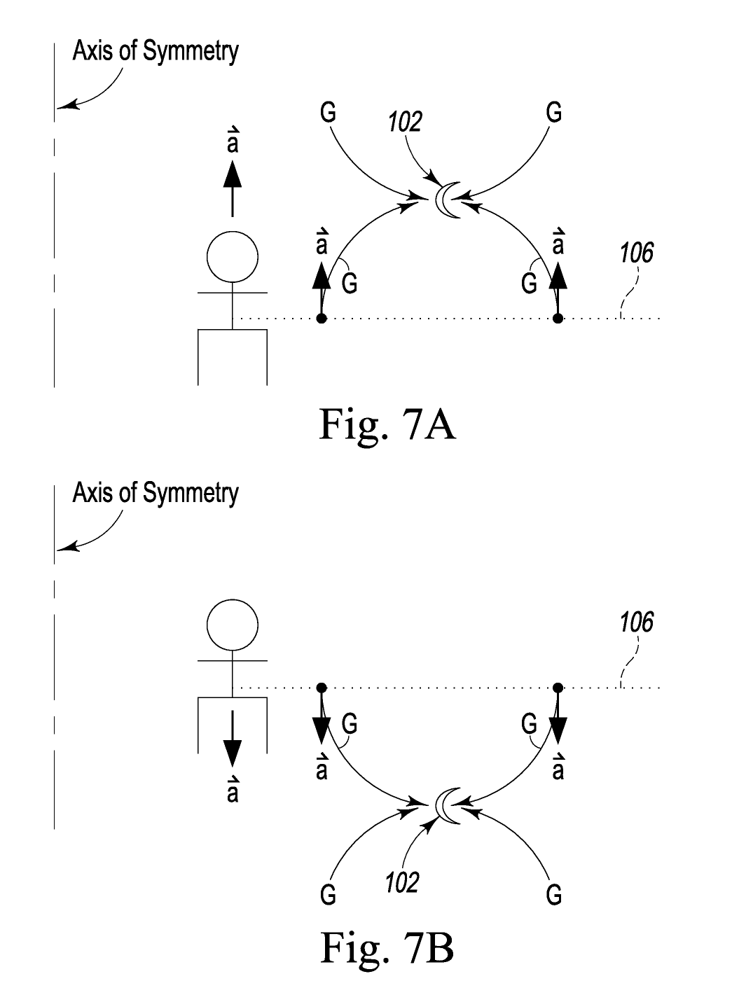

Plasma 102, shown in FIG. 1 only in the confinement region interior to confinement field coil 100b but which occupies any confinement region interior to any of the field coils, is made up of individual charged particles confined to helical paths along magnetic field lines 101 and etc. as is known to those with skill in the art. Alternating the direction of current in the field coils (when the coils are wound each in the same direction) causes the coils to repel but when held in proximity will induce magnetic mirror charged particle reflection, at points in regions of space 105, along field lines approaching the gap between field coils (see FIGS. 5A-C and accompanying description). These regions of increased magnetic field strength (relative to magnetic field strength along the equatorial plane of the adjacent field coil) will reflect charged particles traveling along magnetic field lines with loss of mass m (see FIG. 4) through a velocity-space loss cone as is known to those with skill in the art. Mass m in one embodiment may be a feature of the devise, for example for separation of charged particles through the loss cone, or an inefficiency, for example while adding mass-energy for the creation of an acceleration field G (see FIG. 7). The resulting plasma charged particles will alternately reflect between magnetic mirror reflection points with arc of plasma curvature along field lines as indicated in FIG. 1. Without centrifugal force plasma 102 will diffuse inward (to the left in FIG. 1) so to induce azimuthal rotation an electric field 104 (and accompanying dashed lines) is created between electrodes 103 interior and proximal to each magnetic field coil. By alternating the polarities ((+) and (−)) of the electrodes 103a, 103b, 103c, and etc., an electric field 104 and etc. is created that alternates in direction along the axial length of the device as indicated by arrow direction following standard convention. Plasma drift is induced in magnetized plasma in the direction of the vector cross product E×B (boldface type indicates electric E and magnetic B vector fields) as is known to those with skill in the art (see General Plasma Physics reference Chen). In the above arrangement of alternating electric and magnetic field polarities the azimuthal direction of plasma drift is constant along the axial length of the device, the magnitude of which is approximately v_{d}=E×B/|B|² to first order. Nearer each mirror reflection point the electric field is greater in magnitude due to proximity of electrodes and thus the drift velocity nearer mirror reflection points is greater (see FIGS. 5A-C and accompanying description). This creates an azimuthal velocity shear which is known by those with skill in the art (see Flow Shear references) to be stabilizing to rotating plasmas.

Operation of the confinement system is thus as follows. Plasma is created and heated by any means and preferentially heated transverse to the magnetic field. For instance this can be accomplished by coaxial inductively-coupled plasma induction coils, each on either radial side of the plasma, operating with opposed currents so as to align their magnetic field directions, for plasma generation or ion (or electron) cyclotron resonance heating. Other means of plasma generation and heating, including capacitive coupling, electromagnetic waves, and neutral beam injection, are known to those with skill in the art. The magnetic confinement field localizes the plasma 102 particles to helical paths along magnetic field lines 101. Azimuthal rotation velocity is set by electric field strength to balance or exceed inward particle diffusion inwardly across magnetic field lines. Plasma particles diffusing outward transversely across magnetic field lines are balanced by the increasing magnetic field strength outward toward field coils 100b and etc. Along magnetic field lines a plasma loss cone, known to those with skill in the art of magnetic mirror reflection of charged particles, may eject charged particles for example for ionic separation of plasma species. Compression of plasma is accomplished by raising the electric and magnetic field strengths slowly as compared to the ion cyclotron frequency for nuclear fusion or any other purpose including matter state change. Plasma is moved along the axial length of the device by inducing an axial gradient in confinement field strength along the axial length of the device by adjusting confinement field coil currents or electric fields or both for ejection of matter in the axial direction for example for the creation of thrust or for compression or rarefraction in an axial region. Generation of a gravitational field is accomplished intrinsically by rotating hollow bodies such as confined plasma. Improvement in gravitational acceleration may be by increase in confined mass or more favorably by increase in rotational velocity.

In the present invention charged particles are trapped in the longitudinal direction (the direction along field lines) by the magnetic mirror effect. Confinement of plasma outward across magnetic field lines is accomplished by means of an increasing magnetic field gradient in this transverse direction. Confinement of plasma radially inward across field lines is accomplished by means of centrifugal force in this transverse direction. The plasma circulates the annular confinement space by means of plasma particle drift in crossed electric and magnetic fields as is well known to those skilled in the art of plasma dynamics. Furthermore, plasma instabilities, specifically the interchange instability, are purposefully eliminated in the present invention by means of a convex magnetic field line curvature as viewed from the plasma radially outward transversely across magnetic field lines, which is analogous to a sufficiently increasing magnetic pressure, supplemented by plasma drift velocity shear. The angular velocity of plasma rotation is designated to eliminate inward particle diffusion. Plasma flow shear is accomplished by the effect of electrode placement on the inner face of the field coils, thereby producing increasing electric field strength nearer mirror reflection points. Plasma ionization and heating may be by any means.

### Example

One embodiment of the present invention, as shown in FIG. 1 a simplified example of a real-world device, 25-cm radius by 50-cm radius ellipse (in axial cross-section) of at minimum three field coils of 12-gauge copper magnet wire are wound to approx. 90% fill (using hexagonal packing of approx . . . 106700 turns) and carry 102A current or 108A current in the opposing direction, respectively, alternating from center coil outward. The resulting magnetic field at 10 cm interior of the inner wall of the center coil, along its equatorial plane, is approx. 1.85 Tesla and along that field line can achieve a mirror ratio of 3.3. An electric field of 10800 V/m at the aforementioned point induces azimuthal rotation of approx. 5838 meters/second. Alternatively the magnetic field coils may be of any cross-sectional shape, for example, ellipses with major axes in the radial direction and minor axes in the axial direction, or square, to simplify construction, or any shape. It is an object of the present invention to provide means for construction of the device using conventional materials. One such construction method utilizes resistive current elements in the magnetic field coils, for example copper magnet wire, another such construction method utilizes for example superconducting wire in the magnetic field coils. Electrode material may be any suitable material as may be the vacuum vessel within which is found electric and magnetic fields and plasma.

A desirable mode of operation achieves, but is not limited or restricted to achieving, the following conditions: mirror reflection loss cones centered upon the gap between magnetic field coils, and the gap between magnetic field coils for ash collection (or particle separation) small as possible to maintain field strength in mirror regions, is less than 10 cm using conventional magnet wire, or greater if the field coils can support a greater magnetic Lorentz force of pressure or greater current or both. The foregoing best mode of operation is achieved by suitable adjustment of coil currents to maintain loss cone position to the gap between field coils otherwise particles ejected through the loss cone will impinge upon the electrode or the vacuum vessel wall, causing potential damage.

Bitter plates: In an embodiment of the present invention, magnetic field coils are constructed of conductive plates for example Bitter plates and derivatives thereof such as for example those of the Split florida-helix magnet of USPTO Application US20070210884 A1 to Bird, et. al. It is an object of the present invention to provide means for heat removal from coils and device by providing channels for fluid flow within the field coils and Bitter plates are ideally suited for this requirement and also provide means for carrying high currents and strength under accordingly high Lorentz forces resulting from coil currents.

Electrode shape: In another embodiment of the present invention the electrodes are shaped to induce a velocity shear in the plasma by inducing a variable electric field across the confining magnetic field, varying in both electric field direction and value. Preferentially the electrodes are shaped, or varied, according to the desired stabilizing effects of velocity shear as discussed by Hassam (A. B. Hassam Physics of Fluids B vol. 4, no. 3, p. 485, March 1992), Huang and Hassam (Yi-Min Huang and A. B. Hassam, Physical Review Letters, vol. 87, no. 23, 3 Dec. 2001), and others referenced therein. By nature of the electric field of electrodes with decreasing separation distance, as shown in FIG. 1 nearer the mirror reflection points, the electric field there increases toward the mirror reflection points. It is an object of the present invention to provide means for adjusting the electric field both along the axial length of the device and between individual adjacent mirror reflection points and one such means of adjustment is by inducing a gap between electrode and the inner surface of the magnetic field coil. This can be accomplished by actuating a device to physically move the electrode in any of the axial, radial, or azimuthal directions, or by utilizing a plurality of individual electrodes in place of single electrode adjacent to a field coil, each electrode segment adjusted to an individual potential and position. It is an object of the present invention to provide means of plasma stabilization and these adjustments may provide those means.

Aspect ratio: In another embodiment of the present invention the plasma-device aspect ratio, as measured by the radius of the center of the plasma annulus along its equatorial plane divided by the height of plasma as measured between mirror reflection points is greater than ˜16 as discussed by Hassam and Huang, Physical Review Letters v. 91 n. 19, 7 Nov. 2003, or any value as permitted by technology. It is an object of the present invention to provide means for improving the device aspect ratio to either above or below 16 as device utility requires and this may be accomplished by increasing the magnetic field strength by means of Bitter plates or superconducting wire or both, and altering the rotational velocity rate by means of the electric field, magnetic field, or both.

Changing Mr profile: In another embodiment of the present invention the currents in the magnetic field coils, the electric field produced by the electrodes, or both, are set at values, or varied in time, or varied along the axis of the device, to induce localized variation of the plasma density, rotational velocity, or both, for example, to increase or decrease a mirror ratio in one confinement region as compared to that in an adjacent region, or to induce mass ejection through a specified loss cone. For example, plasma in five adjacent confinement regions may be moved, compressed, or both, to a single confinement region, by adjusting magnetic field strengths, electric field strengths, or both, in distal confinement regions. It is an object of the present invention to provide a means for adequately cooling the device and movement or decompression of plasma or both are means of accomplishing this requirement while maintaining plasma confinement. It is another object of the present invention to provide a means for ejecting a desired species out through the space between field coils, via the plasma loss cone as is known to those with skill in the art, and localized adjustment of the minor ratio and field strengths along the axial length accomplishes this. It is another object of the present invention to provide a means of increasing plasma density or mass or both and a means of accomplishing this is by concentration of distal plasma to a proximal target confinement region or regions.

Axial movement: In another embodiment of the present invention plasma is moved from localization at one confinement region interior to one magnetic field coil, to localization to an adjacent confinement region, or beyond, by increasing the magnetic field strength of a distal magnetic field coil or coils, or by decreasing the magnetic field strength of proximal target magnetic field coil or coils, or both, thereby moving plasma along the device axis through a sequence of one or more minor reflection regions. An object of the present invention is the generation of thrust by the ejection of in the axial direction of mass and a means of accomplishing this is the movement of plasma in the axial direction by means of adjusting currents in adjacent magnetic field coils.

Many coils: In another embodiment of the present invention the number of magnetic field coils, or electrodes, or both, is increased beyond three. In a simplified embodiment of the present invention the number of electrodes may be three minimum with three field coils to create one confinement region with two mirror reflection points. In another example the number of mirror coils and electrodes may be many. It is an object of the present invention to provide a means of creating a gravitational field and movement of rotating plasma sufficiently above or below an equatorial plane to create the desired acceleration requires a device with a sufficient overall axial length.

Although the drawing represents an embodiment of various features and components according to the present invention, the drawing is not necessarily to scale and certain features may be enhanced in order to better illustrate and explain the present invention. The exemplifications set out herein thus illustrate embodiments of the invention, and such exemplifications are not to be construed as limiting the scope of the invention in any manner.

While the invention has been illustrated and described in detail in the foregoing drawing and description, the same is to be considered as illustrative and not restrictive in character, it being understood that only an illustrative embodiment thereof have been show and described and that all changes and modifications that are within the scope of the following claims are desired to be protected.

### REFERENCES

The following references and their references are hereby specifically incorporated herein by this reference.

General Plasma Physics References
Chen, F. F.; Introduction to Plasma Physics and Controlled Fusion. Volume 1, Plasma Physics. Springer; 2nd edition (May 31, 2006). ISBN-13: 978-0306413322
Cambel, Ali Bulent.; Plasma Physics and Magnetofluid-mechanics. McGraw-Hill, 1963.

Flow Shear References:
A. B. Hassam Physics of Fluids B vol. 4, no. 3, p. 485, March 1992
Yi-Min Huang and A. B. Hassam, Physical Review Letters, vol. 87, no. 23, 3 Dec. 2001

Relativity References:
Thirring, H. Über die Wirkung rotierender ferner Massen in der Einsteinschen Gravitationstheorie. Physikalische Zeitschrift 19, 33 (1918). (On the Effect of Rotating Distant Masses in Einstein's Theory of Gravitation)
Thirring, H. Berichtigung zu meiner Arbeit: “Über die Wirkung rotierender Massen in der Einsteinschen Gravitationstheorie”. Physikalische Zeitschrift 22, 29 (1921). (Correction to my paper “On the Effect of Rotating Distant Masses in Einstein's Theory of Gravitation”)
Lense, J. and Thirring, H. Über den Einfluss der Eigenrotation der Zentralkörper auf die Bewegung der Planeten and Monde nach der Einsteinschen Gravitationstheorie. Physikalische Zeitschrift 19 156-63 (1918) (On the Influence of the Proper Rotation of Central Bodies on the Motions of Planets and Moons According to Einstein's Theory of Gravitation)
C. W. MISNER, K. S. THORNE, J. A. WHEELER: Gravitation. W.H. Freeman and Company Limited, Reading (England) 1973.

What is claimed is:

1. A plasma confinement device as shown and described herein.

2. A method for confinement of plasma as shown and described herein.
